(19) United States
(12) Patent Application Publication
(10) Pub. No.: US 2026/0058889 A1
(43) Pub. Date: Feb. 26, 2026

(54) NWDAF-Assisted Discovery of Network Applications

(71) Applicant: Telefonaktiebolaget LM Ericsson (publ), Stockholm (SE)

(72) Inventors: Gonzalo Hernandez Haro, Madrid (ES); Miguel Angel Muñoz De La Torre Alonso, Madrid (ES); Carlota Villasante Marcos, Madrid (ES)

(21) Appl. No.: 19/103,287

(22) PCT Filed: Sep. 12, 2022
(86) PCT No.: PCT/IB2022/058584

§ 371 Date: Feb. 12, 2025

(30) Foreign Application Priority Data
Aug. 17, 2022 (EP) 22382787.4

(51) Int. Cl. H04L 43/026; H04L 41/14; H04L 41/342

(52) U.S. Cl. CPC H04L 43/026; H04L 41/14; H04L 41/342

(57) ABSTRACT

A network node 1000 in a wireless communication network 100 receives, from a consumer Network Function, NF, a request for an analytics service provided by a Network Data Analytics Function, NWDAF 130, executing on the network node 1000. The request comprises one or more filter criteria. The network node 1000 collects data from one or more NFs within the wireless communication network 100. The network node 1000 generates Packet Flow Description, PFD, information from the collected data based on the filter criteria and sends the PFD information to the consumer NF 115. The consumer NF 115 assigns an application identifier to the PFD information and sends a PFD comprising the application identifier and PFD information to an SMF 180.

### RELATED APPLICATIONS

The present application claims priority to EP Patent Application 22382787.4, which was filed Aug. 17, 2022, the disclosure of which is incorporated herein by reference in its entirety.

### TECHNICAL FIELD

The present disclosure generally relates to the technical field of wireless communication networks and, more specifically, to network management techniques that leverage analytics platforms.

### BACKGROUND

In the field of wireless communication networks, a Network Data Analytics Function (NWDAF), traditionally, is an operator managed network analytics logical function that executes on a network node within the Fifth Generation (5G) Core (5GC) reference architecture. The NWDAF traditionally interacts with various other entities within a 5G system for a variety of different purposes. For example, the NWDAF may perform data collection based on event subscriptions provided by an Access and Mobility Function (AMF), Session Management Function (SMF), Policy Control Function (PCF), Unified Data Management (UDM), Application Function (AF) (either directly or via a Network Exposure Function (NEF)), and/or an Operations, Administration, and Maintenance (OAM) node. The NWDAF can also retrieve information from one or more data repositories (e.g., a Unified Data Repository (UDR) via a UDM for subscriber-related information). The NWDAF can also retrieve information about Network Functions (NFs), e.g., a Network Repository Function (NRF) for NF-related information and/or a Network Slice Selection Function (NSSF) for network slice-related information. Moreover, the NWDAF is able to provision analytics on-demand to consumers of analytics data.

The Packet Flow Description Function (PFDF) has the capability to create, update, or remove Packet Flow Descriptions (PFDs) in the NEF, and distribute information from the NEF to the SMF and ultimately to the User Plane Function (UPF). The PFDF may be used in this way, e.g., when the UPF is configured to detect a particular application provided by an Application Service Provider (ASP). Traditionally, the PFDF is a logical function within the NEF.

The NEF is traditionally able to send PFDs to the SMF for a particular application identifier or for a set of application identifiers (e.g., using the PFDF). This may be achieved provided that the NEF (or PFDF) and SMF are able to create, update, and remove individual or the whole set of PFDs from each other.

### SUMMARY

Embodiments of the present disclosure provide analytics regarding application traffic. Particular embodiments provide new PFDs for unknown applications and/or updated PFDs for known applications by identifying the signature of particular network traffic (e.g., browsing, video streaming) and inferring the corresponding application's identity. Embodiments additionally or alternatively provide a mechanism by which a consumer of analytics data informs NFs in the network how new applications provided as output of the NWDAF's analytics are to be named.

Particular embodiments of the present disclosure include a method implemented by a network node in a wireless communication network. The method comprises receiving, from a consumer Network Function (NF), a request for an analytics service provided by a Network Data Analytics Function (NWDAF) executing on the network node. The request comprises one or more filter criteria. The method further comprises collecting data from one or more NFs within the wireless communication network. The method further comprises generating Packet Flow Description (PFD) information from the collected data based on the filter criteria. The method further comprises sending the PFD information to the consumer NF.

In some embodiments, the consumer network function is a Network Exposure Function (NEF) and/or Packet Flow Description Function (PFDF).

In some embodiments, the method further comprises fetching PFDs from an NEF or PFDF. Generating the PFD is responsive to the collected data comprising session data that does not match any of the fetched PFDs.

In some embodiments, collecting the data from the one or more NFs comprises collecting historical data from an Analytical Data Repository Function (ADRF).

In some embodiments, collecting the data from the one or more NFs comprises collecting Quality of Service (QoS) data from a Session Management Function (SMF).

In some embodiments, the method further comprises identifying a traffic pattern from the collected data that matches the filter criteria. Generating the PFD information comprises generating the PFD information for an application responsible for producing the traffic pattern.

Other embodiments include a method implemented by a network node in a wireless communication network, the method comprising sending, to an NWDAF, a request for an analytics service. The request comprises one or more filter criteria. The method further comprises receiving, from the NWDAF 130, PFD information that matches the filter criteria. The method further comprises assigning an application identifier to the PFD information. The method further comprises sending a PFD comprising the application identifier and PFD information to an SMF.

In some embodiments, the method further comprises receiving a PFD fetch request from the NWDAF. The method further comprises sending a plurality of PFDs to the NWDAF in response to the PFD fetch request. The PFD sent to the SMF is distinct from each of the PFDs sent to the NWDAF.

In some embodiments, sending the PFD to the SMF comprises sending the PFD to a User Plane Function (UPF) via the SMF for inclusion of the PFD in enforcing user plane policies.

Certain features may be applied to any of the methods described herein. For example, in some embodiments, the filter criteria comprises an indicator of one or more user equipment identities. In some embodiments, the filter criteria comprises a predominant traffic flow direction. In some embodiments, the filter criteria comprises a metric describing packet size characteristics. In some embodiments, the filter criteria comprises a metric describing traffic reception and/or transmission characteristics.

Yet other embodiments include a network node comprising processing circuitry and a memory. The memory contains instructions executable by the processing circuitry whereby the network node is configured to receive, from a consumer NF, a request for an analytics service provided by an NWDAF executing on the network node. The request comprises one or more filter criteria. The network node is further configured to collect data from one or more NFs within the wireless communication network. The network node is further configured to generate PFD information from the collected data based on the filter criteria. The network node is further configured to send the PFD information to the consumer NF.

In some embodiments, the network node is further configured to perform any of the methods above in which the network node is executing an NWDAF.

Still other embodiments include a network node comprising processing circuitry and a memory. The memory contains instructions executable by the processing circuitry whereby the network node is configured to send, to an NWDAF, a request for an analytics service. The request comprises one or more filter criteria. The network node is further configured to receive, from the NWDAF, PFD information that matches the filter criteria. The network node is further configured to assign an application identifier to the PFD information. The network node is further configured to send a PFD comprising the application identifier and PFD information to an SMF.

In some embodiments, the network node is further configured to perform any of the methods above in which the network node sends a request for an analytics service to an NWDAF.

Further embodiments include a computer program, comprising instructions which, when executed on processing circuitry of a network node, cause the processing circuitry to carry out any of the methods described above.

Still further embodiments include a carrier containing any of the computer programs discussed above. The carrier is one of an electronic signal, optical signal, radio signal, or computer readable storage medium.

### BRIEF DESCRIPTION OF THE DRAWINGS

Aspects of the present disclosure are illustrated by way of example and are not limited by the accompanying figures.

FIG. 1 is a schematic block diagram illustrating an example wireless communication network according to one or more embodiments of the present disclosure.

FIG. 2 is a table illustrating an example definition of an event exposed by an NWDAF according to one or more embodiments of the present disclosure.

FIG. 3 is a table illustrating example input data collected by an NWDAF for use in generating analytics, according to one or more embodiments of the present disclosure.

FIG. 4 is a table illustrating example PDF information produced by an NWDAF according to one or more embodiments of the present disclosure.

FIG. 5 and FIG. 6 are signaling diagrams illustrating examples of signaling between network functions according to different embodiments of the present disclosure.

FIG. 7 is a flow diagram illustrating an example method implemented by a network nodes executing an NWDAF, according to one or more embodiments of the present disclosure.

FIG. 8 is a flow diagram illustrating an example method implemented by a network nodes executing an NEF, according to one or more embodiments of the present disclosure.

FIG. 9 is a schematic block diagram illustrating an example network node according to one or more embodiments of the present disclosure.

### DETAILED DESCRIPTION

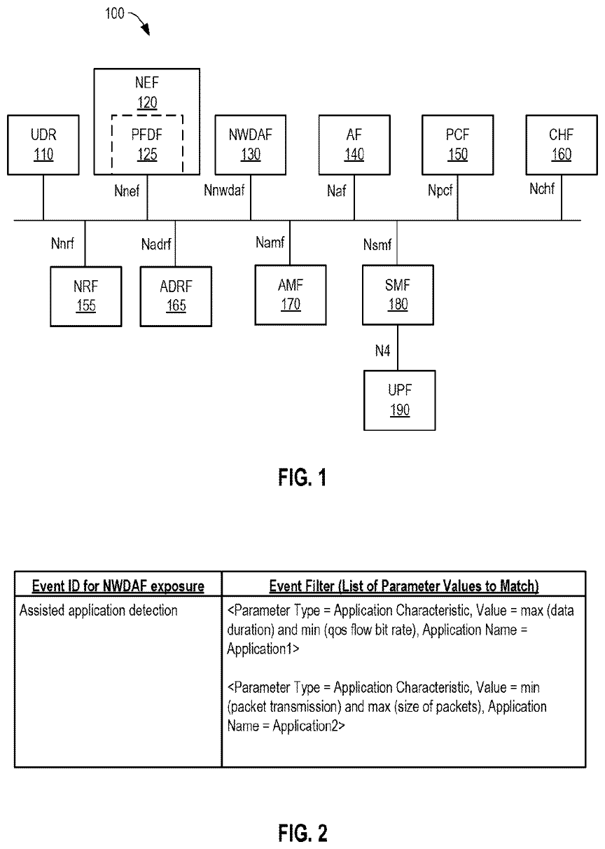

FIG. 1 is a schematic block diagram illustrating an example network 100 comprising a plurality of NFs according to one or more embodiments of the present disclosure. The network 100 is compliant with the 5G reference architecture and includes a UDR 110, NEF 120, NWDAF 130, AF 140, PCF 150, NRF 155, Charging Function (CHF) 160, Analytical Data Repository Function (ADRF) 165, AMF 170, SMF 180, and UPF 190, each of which may execute individually or with any one or more of the others on a network node. The NEF 120 in particular may comprise a PFDF 125. Each of the nodes has its own interface through which it can be reached on the network. With the exception of the interface between the UPF 190 and SMF 180, the interface to each of the NFs is designated by an N prefixed to the name of the NF (e.g., the UDR 110 can be reached on the network via the Nudr interface). The interface between the UPF 190 and the SMF 180 is known as the N4 interface.

In order for the network 100 to provide differentiated application traffic handling, the network 100 distinguishes the traffic produced by different applications. In a 5G network, an application can be distinguished by a packet header of a Service Data Flow (SDF) and/or by application identifier. The most common approach to detect traffic is use packet headers, which often include source and destination addresses. The application identifier may be used for referring to the UPF's specific application detection filter and the AF 140 may provide PFDs to update application detection filter information associated with the application identifier.

A PFD may include a flow description (e.g., a service-side 3-tuple), Uniform Resource Locator (URL), and domain name/protocol information. When an AF 140 delivers a PFD to the NEF 120 (e.g., to the PFDF 125), the PFD may be distributed to SMFs 180 and UPFs 190 to enable flow detection. In particular, the SMF 180 may provision or remove PFDs associated with a specific application identifier. However, there may be instances when the ASP fails to provide initial PFD information or provides the initial PFD information but fails to update it on a timely basis. In such circumstances, the UPF 190 will be unable to detect corresponding application traffic.

In view of this problem, embodiments of the present disclosure provide analytics regarding application traffic. Particular embodiments provide new PFDs for unknown applications and/or updated PFDs for known applications by identifying the signature of particular network traffic (e.g., browsing, video streaming) and inferring the corresponding application's identity. To accomplish this, one or more embodiments include collecting measurements of an application in order to extract statistical characteristics and collecting packet payloads to extract payload characteristics (such as the domain name contained in the payload. The captured application characteristics may then be stored as a PFD, which may be used by the SMF 180 and/or UPF 190 to detect an application.

In particular, the NWDAF 130 could collect current and historical PFD information (including application identifier, historical IP 3-tuple, historical URL, historical domain name information) from the NRF via the NEF 120 (PFDF 125) and ADRF 165 respectively. In general, the ADRF 165 allows NF consumers to store, retrieve, and remove data or analytics. Based on PFD information discerned from the ADRF 165, NRF, and traffic information from UPF, new PFD information (including application identifier, new IP 3-tuple, new URL, new Domain name information) for the existing application identifier could be derived by the NWDAF 130. The new PFD information provided by the NWDAF 130 can be used by the NEF 120 for provisioning the SMF 180 and/or UPF 190.

The SMF 180 can request provisioning of the PFDs associated with a given application identifier and translate the Policy and Charging Control (PCC) rules associated with the application identifier into Packet Detection Rules (PDRs) for installation on the UPF 190. For example, the SMF 180 may receive a PCC rule associated with application ID 1. If application ID 1 is not already stored in the SMF 180, the SMF 180 may request, from the NEF 120, the PFDs associated with application ID 1. The SMF 180 may send the PFDs for application ID 1 to the UPF 190, and then translate the PCC rule to a PDR that references application ID 1.

In order to do this, the SMF 180 needs to know the application ID of the appropriate PFDs so that the application ID may be assigned a PCC rule with the desired traffic policies.

Also, the consumer of the analytic (e.g., the NEF 120) may be interested in only a subset of the applications found by the NWDAF 130. Accordingly, embodiments of the present disclosure propose a new analytics filter to enabling the NWDAF 130 to filter the applications provisioned to the analytics consumer and to provide input to the NWDAF 130 for naming the applications found.

In particular, embodiments of the present disclosure allow the consumer to inform the NWDAF 130 about target applications of interest through the “Application Characteristics” parameter. The “Application Characteristics” parameter is a well-known mechanism for identifying relevant Key Performance Indicators (KPIs) with regard to traffic characteristics. According to embodiments, the Application Characteristics parameter is used to describe the relations for identifying applications.

The contents of the application characteristics parameter are created from traffic features provided by the UPF 190 as input for the relevant data collection in combination with an application relation function. The traffic features may include, e.g., data duration, Quality of Service (QoS) flow bit rate, packet transmission, size of packets, data volume, and/or uplink/downlink packet delay. The application relation function may include, e.g., min ( ), application with the minimum value, max ( ), application with the maximum value. Several characteristics can be used per filter using and/or operators.

FIG. 2 is a table illustrating an example event exposed by the NWDAF 130 to consumer NFs in the network 100. In this example, the event is called “Assisted application detection.” The event is associated with an event filter list. The event filter list allows a filter to be described for each of a plurality of applications using the Application Characteristic parameter. As shown in FIG. 2, Application1 is described as an application in which traffic has a maximum data duration and minimum QoS flow bit rate. Application2 is described as an application in which traffic has a minimum packet transmission and maximum packet size. Any number of event filters may be defined in this way for any number of applications.

The name specified in the Application Characteristics parameter is used by the NWDAF 130 to name applications that match the characteristics listed. In response to receiving one or more Application Characteristics filters in an analytics subscription request, the NWDAF 130 will provide analytics about the applications matching the filters. In response to there being overlapping PFD information provided by the NWDAF 130 and by the AF 140, the information provided by the AF 140 takes precedence over the PFD information provided by NWDAF 130 in at least some embodiments. Thus, embodiments of the present disclosure provide a mechanism by which a consumer of analytics data informs the NWDAF 130 regarding how to identify and name applications from traffic analytics.

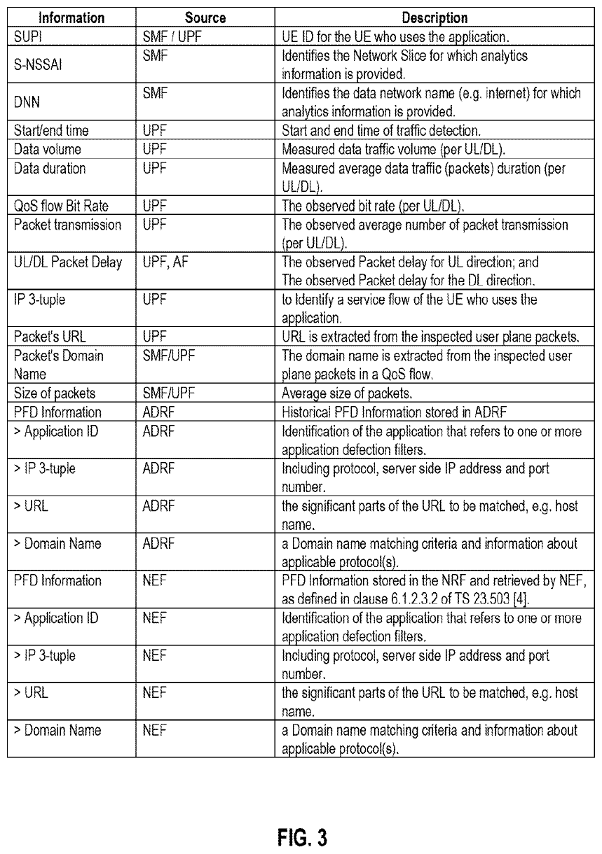

FIG. 3 is a table that lists example data that may be collected by the NWDAF 130 from various sources in the network 100 for use in identifying an application having certain characteristics specified by an analytics consumer. The inputs may include QoS flow related data from the SMF 180, e.g., for a specific Single Network Slice Selection Assistance Information (S-NSSAI), Domain Network Name (DNN), and/or UE.

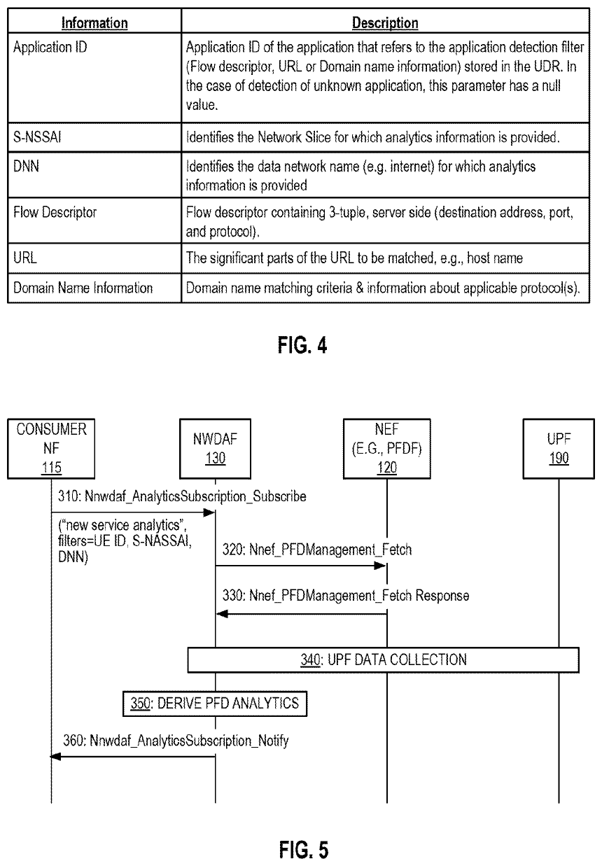

FIG. 4 is a table listing example output analytics produced by the NWDAF 130 according to one or more embodiments of the present disclosure. The output can be used to provision new PFDs for known applications or define new PFDs for new applications not known to the NEF 120 yet. Upon receiving the analytics including new PFD information from the NWDAF 130, the NEF 120 can assign a PFD ID for the unknown application. Moreover, the assigned PFD ID can be used to identify, audit, and report the unknown application.

In view of the above, FIG. 5 is a signaling diagram illustrating example signaling for obtaining analytics from a network node of the network 100. According to the example of FIG. 5, a consumer NF 115 subscribes to the NWDAF 130 to request analytics for application detection (step 310). The consumer NF 115 may be any NF of the network 100 and, in particular, may be the NEF 120 (or PFDF 125 thereof). This subscription may, e.g., be triggered by local configuration or by Operations, Administration, and Maintenance (OAM). The subscription comprises an indicator that new service analytics is being requested and may additionally include an analytics filter. The analytics filter may include a UE ID, an S-NSSAI, and/or a DNN.

The NWDAF 130 fetches currently stored PFD information from the NEF 120 (e.g., via a PFDF 125 of the NEF 120) by sending a fetch request to the NEF (step 320) and receiving a corresponding fetch response (step 330). Although not shown in the figure, the NWDAF may also fetch historical data from an ADRF.

The NWDAF 130 collects session related information from the UPF 190 about URL, domain name part, and Internet Packet (IP) 3-tuples of packets from one or more SDFs not matching installed PDRs (step 340). The NWDAF 130 derives PFD analytics, e. g, based on the gathered UPF data and/or the analytics filter received from the NF consumer (step 350). The NWDAF 130 notifies the analytics consumer NF 115 with output that is consistent with the consumer NF's earlier request.

To support particular embodiments of the present disclosure, certain network functions will need to be adapted from their traditional behaviors in certain ways. For example, in some embodiments, the NWDAF 130 provides a new analytic for application detection information. Additionally or alternatively, the NWDAF 130 processes user plane data for extracting traffic characteristics. Additionally or alternatively, the NWDAF 130 filters and names the applications detected based on an “Application Characteristics”filter.

The UPF 190 may additionally or alternatively need to be adapted. In some embodiments, the UPF 190 reports URL, domain name part, and IP 3-tuples of packets from unknown application to the NWDAF 130. Additionally or alternatively, the UPF 190 provides requested sessions statistics including data volume, data duration, QoS flow bit rate and packet transmission.

The NEF 120 (e.g., at the PFDF 125) may additionally or alternatively need to be adapted. In particular the NEF 120 may need to supports consuming new PFD information from the NWDAF 130.

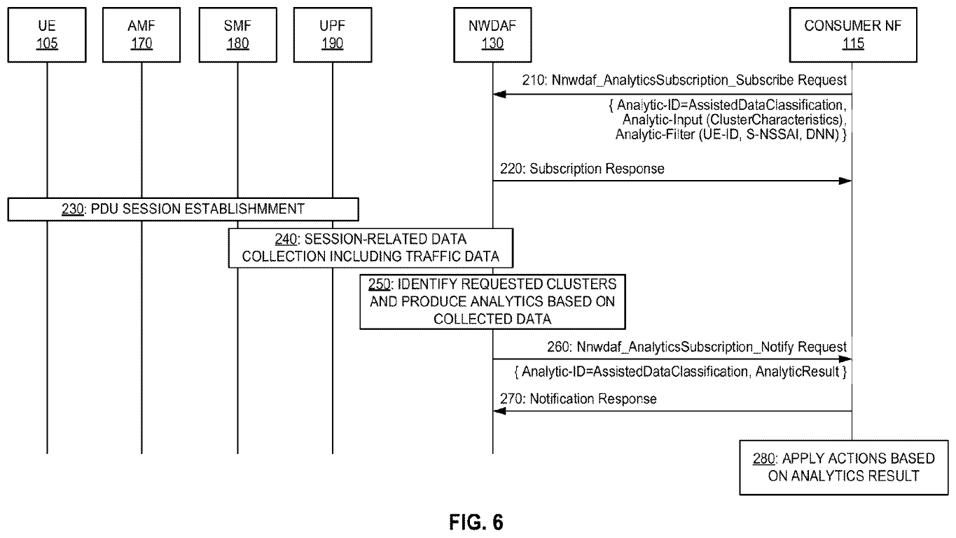

FIG. 6 is a flow diagram illustrating another example of signaling according to particular embodiments of the present disclosure. As shown in FIG. 6, a consumer NF 115 (e.g., an NEF 120 or PFDF 125) subscribes to assisted application detection provided by the NWDAF 130. To do so, the consumer 115 sends a subscription request (step 210) to the NWDAF 130, e.g., as a Nnwdaf_AnalyticsSubscription_Subscribe request message. The subscription request may be a request to subscribe to a classification service provided by the NWDAF 130 and include one or more parameters as input, such as an Analytic-ID parameter, an Analytic-Input parameter, and/or an Analytic-Filter input.

In the example of FIG. 6, the Analytic-ID parameter is set to a value indicating AssistedApplicationDetection and the Analytic-Filter is set to an identifier of a UE 105 (i.e., a UE-ID), a Single-Network Slice Selected Assistance Information that identifies a relevant network slice, and a Data Network Name (DNN). The Analytic-Input parameter may be a data element or structure (in this example called “ClusterCharacteristics”) that describes the relationship between clusters that will allow the NWDAF 130 to identify and assign to each of the clusters an application name.

For example, the ClusterCharacteristics parameter may describe, for a first application, a cluster having a higher than average packet size and with traffic flowing predominantly in the uplink direction, whereas for a second application, the ClusterCharacteristics parameter may describe a cluster with a lower standard interarrival time and a higher maximum retransmission packets. Thus, the ClusterCharacteristics parameter may describe criteria by which a cluster may be identified from traffic data stored at the NWDAF 130.

The NWDAF 130 answers the consumer 115 by providing a subscription response that indicates that the operation was successful (step 220). Subsequently, a Packet Data Unit (PDU) session is established for a UE 105 (step 230). For purposes of simplicity, in this example, it is assumed that there is a single UE 105, which was identified by the UE-ID indicated in the Analytic-Filter parameter of the subscription request.

The NWDAF 130 collects session related data including traffic data, e.g., using the SMF 180 or UPF 190 (step 240).

Based on the collected data and the cluster characteristics provided by the consumer 115 in the subscription request, the NWDAF 130 identifies the requested clusters and produces analytics (step 250). In order for the clusters to be identifiable, the NWDAF 130 uses the specified dynamic relationships to assign names to the found clusters, which may be referred to as applications within the network that have a particular traffic type.

The NWDAF 130 sends the analytic result to the consumer 115 in a notification message (step 260). In this example, the notification message is an Nnwdaf_AnalyticsSubscription_Notify request message that includes the previously mentioned Analytic-ID along with an AnalyticResult parameter. The AnalyticResult parameter includes the newly-detected application of a given traffic type and includes its corresponding naming.

The consumer 115 sends a notification response message to the NWDAF 130 indicating that the notification operation was successful (step 270). As a result, the consumer 115 may apply corresponding actions based on the AnalyticResult. For example, the consumer 115 may store the new applications and/or traffic types in the NEF 120, PFDF 125, UDR 110, or elsewhere as Application Data and distribute the information to the UPF 190 for traffic classification. This way, policies corresponding to the identified traffic may be applied in an automated way.

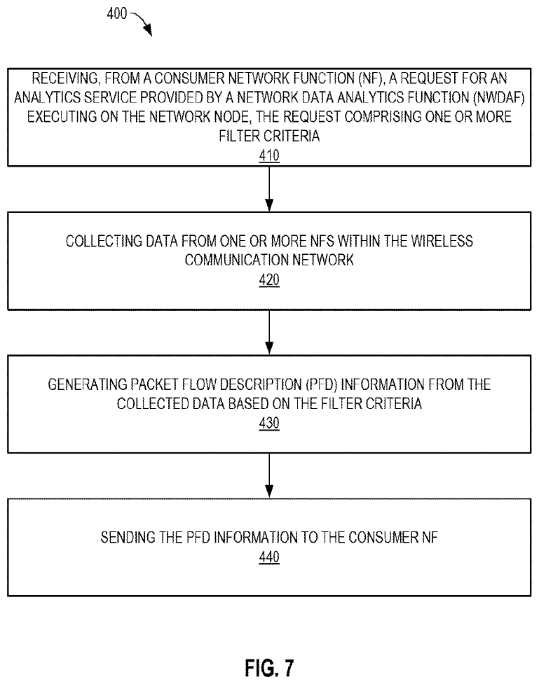

In view of the above, embodiments of the present disclosure include a method 400 as shown in the example of FIG. 7. The method is implemented by a network node in a communication network 100. The method 400 comprises receiving, from a consumer NF 115, a request for an analytics service provided by an NWDAF 130 executing on the network node (block 410). The request comprises one or more filter criteria. The method 400 further comprises collecting data from one or more NFs within the wireless communication network 100 (block 420). The method 400 further comprises generating PFD information from the collected data based on the filter criteria (block 430). The method 400 further comprises sending the PFD information to the consumer NF 115 (block 440).

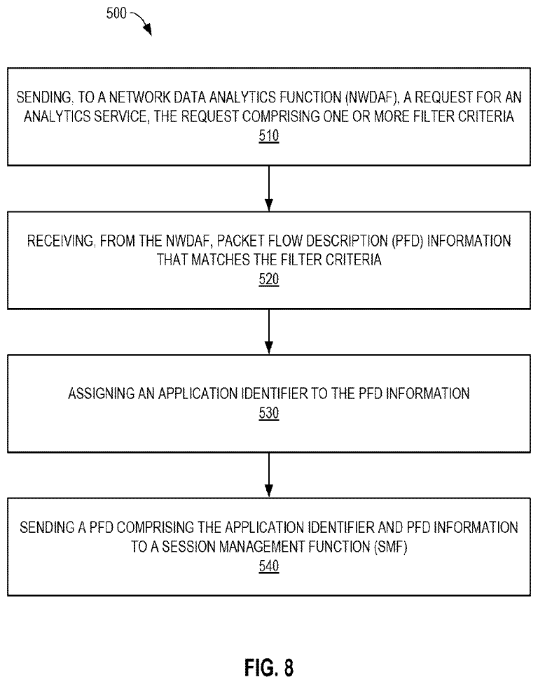

Correspondingly, embodiments of the present disclosure include a method 500 as shown in the example of FIG. 8. The method 500 is implemented by a network node within a communication network 100. The method 500 comprises sending, to an NWDAF 130, a request for an analytics service (block 510). The request comprises one or more filter criteria. The method 500 further comprises receiving, from the NWDAF, PFD information that matches the filter criteria (block 520). The method 500 further comprises assigning an application identifier to the PFD information (block 530). The method 500 further comprises sending a PFD comprising the application identifier and PFD information to an SMF 180 (block 540).

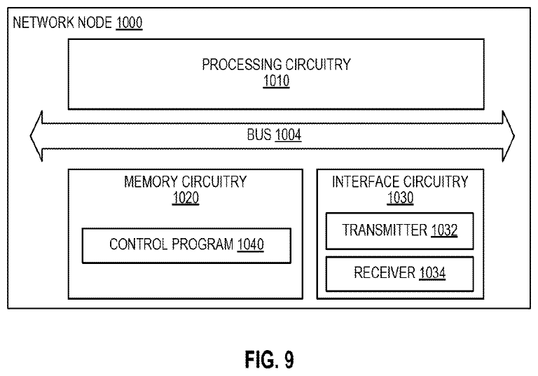

Other embodiments of the present disclosure include a network node 1000 implemented as schematically illustrated in the example of FIG. 9. The example network node 1000 of FIG. 4 comprises processing circuitry 1010, memory circuitry 1020, and interface circuitry 1030. The processing circuitry 1010 is communicatively coupled to the memory circuitry 1020 and the interface circuitry 1030, e.g., via a bus 1004. The processing circuitry 1010 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 1010 may be programmable hardware capable of executing software instructions stored, e.g., as a machine-readable control program 1040 in the memory circuitry 1020. The memory circuitry 1020 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 1030 may be a controller hub configured to control the input and output (I/O) data paths of the network node 1000. Such I/O data paths may include data paths for exchanging signals over a network. The interface circuitry 1030 may be implemented as a unitary physical component, or as a plurality of physical components that are contiguously or separately arranged, any of which may be communicatively coupled to any other or may communicate with any other via the processing circuitry 1010. For example, the interface circuitry 1030 may comprise a transmitter 1032 configured to send wireless communication signals and a receiver 1034 configured to receive wireless communication signals.

According to particular embodiments, the processing circuitry 1010 is configured to receive, from a consumer NF 115, a request for an analytics service provided by an NWDAF 130 executing on the network node 1000. The request comprises one or more filter criteria. The processing circuitry 1010 is further configured to collect data from one or more NFs within the wireless communication network 100. The processing circuitry 1010 is further configured to generate PFD information from the collected data based on the filter criteria and send the PFD information to the consumer NF 115 (e.g., via the interface circuitry 1030).

According to other embodiments, the processing circuitry 1010 is configured to send, to an NWDAF 130, a request for an analytics service. The request comprises one or more filter criteria. The processing circuitry 1010 is further configured to receive, from the NWDAF 130, PFD information that matches the filter criteria. The processing circuitry 1010 is further configured to assign an application identifier to the PFD information and send a PFD comprising the application identifier and PFD information to an SMF 180.

Yet other embodiments include a system comprising a first network node configured to perform the method 400 of FIG. 7 and a second network node configured to perform the method 500 of FIG. 8.

Still other embodiments include a control program 1040 comprising instructions that, when executed on processing circuitry 1010 of a network node 1000, cause the network node 1000 to carry out the method 400. Alternatively, the control program 1040 may comprise instructions that, when executed on the processing circuitry 1010 of the network node 1000, cause the network node 1000 to carry out the method 500.

Yet other embodiments include a carrier containing the control program 1040. The carrier is one of an electronic signal, optical signal, radio signal, or computer readable storage medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-19. (canceled)

20. A method, implemented by a network node in a wireless communication network, the method comprising:
receiving, from a consumer Network Function (NF), a request for an analytics service provided by a Network Data Analytics Function (NWDAF) executing on the network node, the request comprising:
an analytics filter describing filter criteria for identifying one or more of a User Equipment Identifier (UE-ID), a Single Network Slice Selection Assistance Information (S-NSSAI) identifier, or a Domain Network Name (DNN); and
an analytics input parameter that describes criteria for identifying a cluster from traffic data that matches the filter criteria and is stored at the NWDAF;
collecting the traffic data from one or more NFs within the wireless communication network;
identifying the cluster based on the collected traffic data, the filter criteria, and the analytics input parameter;
generating Packet Flow Description (PFD) information for the cluster from the collected traffic data based on the filter criteria and the analytics input parameter; and
sending the PFD information to the consumer NF.

21. The method of claim 20, wherein the consumer network function is a Network Exposure Function (NEF) and/or Packet Flow Description Function (PFDF).

22. The method of claim 21, further comprising fetching PFDs from the NEF or the PFDF, wherein generating the PFD is responsive to the collected traffic data comprising session data that does not match any of the fetched PFDs.

23. The method of claim 20, wherein collecting the traffic data from the one or more NFs comprises collecting historical data from an Analytical Data Repository Function (ADRF).

24. The method of claim 20, wherein collecting the traffic data from the one or more NFs comprises collecting Quality of Service (QOS) data from a Session Management Function (SMF).

25. The method of claim 20, further comprising identifying a traffic pattern from the collected traffic data that matches the filter criteria, wherein generating the PFD information comprises generating the PFD information for an application responsible for producing the traffic pattern.

26. The method of claim 20, wherein the filter criteria comprises an indicator of one or more user equipment identities.

27. The method of claim 20, wherein the filter criteria comprises a predominant traffic flow direction.

28. The method of claim 20, wherein the filter criteria comprises a metric describing packet size characteristics.

29. The method of claim 20, wherein the filter criteria comprises a metric describing traffic reception.

30. The method of claim 20, wherein the filter criteria comprises a metric describing traffic transmission characteristics.

31. A method, implemented by a network node in a wireless communication network, the method comprising:
sending, to a Network Data Analytics Function (NWDAF), a request for an analytics service, the request comprising:
an analytics filter describing filter criteria for identifying one or more of a User Equipment Identifier (UE-ID), a Single Network Slice Selection Assistance Information (S-NSSAI) identifier, or a Domain Network Name (DNN); and
an analytics input parameter that describes criteria for identifying a cluster from traffic data that matches the filter criteria and is stored at the NWDAF;
receiving, from the NWDAF, Packet Flow Description (PFD) information that matches the filter criteria and the criteria for identifying the cluster;
assigning an application identifier to the PFD information; and
sending a PFD comprising the application identifier and PFD information to a Session Management Function (SMF).

32. The method of claim 31, further comprising:
receiving a PFD fetch request from the NWDAF; and
sending a plurality of PFDs to the NWDAF in response to the PFD fetch request;
wherein the PFD sent to the SMF is distinct from each of the PFDs sent to the NWDAF.

33. The method of claim 31, wherein sending the PFD to the SMF comprises sending the PFD to a User Plane Function (UPF) via the SMF for inclusion of the PFD in enforcing user plane policies.

34. The method of claim 31, wherein the filter criteria comprises an indicator of one or more user equipment identities.

35. The method of claim 31, wherein the filter criteria comprises a predominant traffic flow direction.

36. The method of claim 31, wherein the filter criteria comprises a metric describing packet size characteristics.

37. The method of claim 31, wherein the filter criteria comprises a metric describing traffic reception and/or transmission characteristics.

38. A network node comprising:
processing circuitry and a memory, the memory containing instructions executable by the processing circuitry whereby the network node is configured to:
receive, from a consumer Network Function (NF), a request for an analytics service provided by a Network Data Analytics Function (NWDAF) executing on the network node, the request comprising:
an analytics filter describing filter criteria for identifying one or more of a User Equipment Identifier (UE-ID), a Single Network Slice Selection Assistance Information (S-NSSAI) identifier, or a Domain Network Name (DNN); and
an analytics input parameter that describes criteria for identifying a cluster from traffic data that matches the filter criteria and is stored at the NWDAF;
collect the traffic data from one or more NFs within the wireless communication network;
identify the cluster based on the collected traffic data, the filter criteria, and the analytics input parameter;
generate Packet Flow Description (PFD) information for the cluster from the collected traffic data based on the filter criteria and the analytics input parameter; and
send the PFD information to the consumer NF.

39. A network node comprising:
processing circuitry and a memory, the memory containing instructions executable by the processing circuitry whereby the network node is configured to:
send, to a Network Data Analytics Function (NWDAF), a request for an analytics service, the request comprising:
an analytics filter describing filter criteria for identifying one or more of a User Equipment Identifier (UE-ID), a Single Network Slice Selection Assistance Information (S-NSSAI) identifier, or a Domain Network Name (DNN); and
an analytics input parameter that describes criteria for identifying a cluster from traffic data that matches the filter criteria and is stored at the NWDAF;
receive, from the NWDAF, Packet Flow Description (PFD) information that matches the filter criteria and the criteria for identifying the cluster;
assign an application identifier to the PFD information; and
send a PFD comprising the application identifier and PFD information to a Session Management Function (SMF).
